(19) United States
(12) Patent Application Publication
(10) Pub. No.: US 2025/0219345 A1
(43) Pub. Date: Jul. 3, 2025

(54) FEMTO-SECOND FIBER LASER SYSTEM OF FEEDBACK STRUCTURE

(71) Applicants: ELECTRONICS AND TELECOMMUNICATIONS RESEARCH INSTITUTE, Daejeon (KR); BlueTileLab, Inc, Daejeon (KR)

(72) Inventors: Hong-Seok SEO, Daejeon (KR); Hyung Woo KIM, Incheon (KR); Dong Hoon SONG, Daejeon (KR)

(73) Assignees: ELECTRONICS AND TELECOMMUNICATIONS RESEARCH INSTITUTE, Daejeon (KR); BlueTileLab, Inc, Daejeon (KR)

(21) Appl. No.: 19/001,165

(22) Filed: Dec. 24, 2024

(30) Foreign Application Priority Data
Dec. 27, 2023 (KR) 10-2023-0192649
Sep. 6, 2024 (KR) 10-2024-0121357

(51) Int. Cl. H01S 3/067; H01S 3/094

(52) U.S. Cl. CPC H01S 3/06758; H01S 3/0675; H01S 3/094003; H01S 3/094042; H01S 3/094053; H01S 3/094076

(57) ABSTRACT

Disclosed is a femtosecond fiber laser system of a feedback structure. The system includes a femtosecond light source configured to generate femtosecond laser light, a pulse picker connected to the femtosecond laser light source and configured to modulate the femtosecond laser light to generate pulsed laser light, first to third main amplifiers connected to the pulse picker and configured to amplify the pulsed laser light, and an optical fiber connected from the femtosecond light source to the third main amplifier.

### CROSS-REFERENCE TO RELATED APPLICATIONS

This U.S. non-provisional patent application claims priority under 35 U.S.C. § 119 of Korean Patent Application Nos. 10-2023-0192649, filed on Dec. 27, 2023, and 10-2024-0121357, filed on Sep. 6, 2024, the entire contents of which are hereby incorporated by reference.

### BACKGROUND

The present disclosure herein relates to a laser system, and more particularly, to a femtosecond fiber laser system of a feedback structure.

Femtosecond laser light may be used for cutting a semiconductor wafer and secondary battery electrodes in an industrial site. The femtosecond laser light may control a repetition rate through a pulse control signal and also be modulated to laser light provided by femtosecond laser pulse trains. Pulsed laser light may reduce cut surface defects of the semiconductor wafer and the secondary battery electrodes. The pulsed laser light may be generated by a femtosecond fiber laser system. A typical femtosecond fiber laser system may use an optical shutter element in the end of the system to switch femtosecond laser light into femtosecond light in a pulse train type. However, the optical shutter element raises issues of increasing the size of the system, increasing power consumption, and having a low switching speed.

### SUMMARY

The present disclosure provides a femtosecond fiber laser system capable of removing and omitting an optical shutter element and preventing damage to a main amplifier during an off-time of pulsed laser light.

An embodiment of the inventive concept provides a femtosecond fiber laser system of a feedback structure, including: a femtosecond light source configured to generate femtosecond laser light; a pulse picker connected to the femtosecond laser light source and configured to modulate the femtosecond laser light to generate pulsed laser light; a first main amplifier, a second main amplifier, and a third main amplifier connected to the pulse picker and configured to amplify the pulsed laser light; and an optical fiber connected from the femtosecond light source to the third main amplifier, wherein each of the first main amplifier, the second main amplifier. Here, the third amplifier includes: a pump light source configured to generate pump light for amplifying the pulsed laser light; and a first attenuation resonator connected to the pump light source and configured to attenuate or remove the pump light during a turn-off time of the pulsed laser light.

In an embodiment, the first attenuation resonator may include: couplers provided in the optical fiber at front and back ends of the pump light source; a first feedback loop fiber connected to the couplers; and a first attenuator connected to the first feedback loop fiber.

In an embodiment, the femtosecond fiber laser system of a feedback structure may further include: a second feedback loop fiber connected between the coupler between the first main amplifier and the pulse picker, and the coupler between the second main amplifier and the third main amplifier, and having a longer length than the first feedback loop fiber; and a second attenuator connected to the second feedback loop fiber.

In an embodiment, the femtosecond fiber laser system of a feedback structure may further include: a third feedback loop fiber connected between the coupler between the first main amplifier and the pulse picker, and the coupler provided at another side of the third main amplifier, and having a longer length than the second feedback loop fiber; and a third attenuator connected to the third feedback loop fiber.

In an embodiment, each of the couplers may include a wavelength division multiplexing (WDM) filter or a polarization multiplexing combiner (PMC).

In an embodiment, each of the first main amplifier, the second main amplifier, and the third main amplifier may further include a gain medium fiber provided adjacent to the pump light source.

In an embodiment, the first attenuation resonator may include fiber Bragg gratings provided in the optical fiber at both sides of the pump light source and the gain medium fiber.

In an embodiment, the first attenuation resonator may include a resonant mirror provided in the optical fiber connected to the pump light source.

In an embodiment, the first attenuation resonator may include a continuous wave laser light source provided in the fiber connected to the pump light source and configured to provide continuous wave laser light.

In an embodiment, the femtosecond fiber laser system of a feedback structure may further include a pulse width compressor connected to the third main amplifier. The pulse width compressor may include: an output mirror; a first grating provided adjacent to the output mirror and configured to diffract the pulsed laser light and the continuous wave laser light; a second grating provided adjacent to the first grating and configured to diffract again the pulsed laser light and the first continuous laser light; a mirror provided adjacent to the second grating and configured to reflect the pulsed laser light to the second grating; and a blocking plate provided between the mirror and the second grating and configured to block the continuous wave laser light.

In an embodiment of the inventive concept, a femtosecond fiber laser system of a feedback structure, includes: a femtosecond light source configured to generate femtosecond laser light; a pulse width extender configured to extend a pulse width of the femtosecond laser light; a preamplifier configured to amplify the femtosecond laser light; a pulse picker configured to modulate the femtosecond laser light to generate pulsed laser light; a first main amplifier, a second main amplifier, and a third main amplifier configured to amplify the pulsed laser light; and a pulse width compressor provided adjacent to the third main amplifier and configured to compress a pulse width of the pulsed laser light. Here, each of the first main amplifier, the second main amplifier, and the third amplifier may include: a pump light source configured to generate pump light; a gain medium fiber provided adjacent to the pump light source and configured to absorb the pump light to amplify the pulsed laser light; and a first attenuation resonator connected to both sides of the pump light source and the gain medium fiber and configured to attenuate or remove the pump light during a turn-off time of the pulsed laser light.

In an embodiment, the first attenuation resonator may include: couplers respectively provided at both sides of the pump light and the gain medium fiber; a first feedback loop fiber connected to the couplers; and a first attenuator connected to the first feedback loop fiber.

In an embodiment, the femtosecond fiber laser system of a feedback structure may further include: a second feedback loop fiber branched from the coupler between the first main amplifier and the pulse picker to be connected to the coupler between the second main amplifier and the third main amplifier, and having a longer length than the first feedback loop fiber; and a second attenuator connected to the second feedback loop fiber.

In an embodiment, the femtosecond fiber laser system of a feedback structure may further include: a third feedback loop branched from the coupler between the first main amplifier and the pulse picker to be connected to the coupler between the third main amplifier and the pulse width compressor, and having a longer length than the second feedback loop fiber; and a third attenuator connected to the third feedback loop fiber.

In an embodiment, the first attenuation resonator may include fiber Bragg gratings provided at both sides of the pump light and the gain medium fiber.

In an embodiment, the first attenuation resonator may include a resonant mirror provided at one side of the pump light source.

In an embodiment, the first attenuation resonator may include a continuous wave laser light source connected to one side of the pump light source and configured to provide continuous wave laser light.

In an embodiment, the pulse width compressor may include: an output mirror; a first grating provided adjacent to the output mirror and configured to diffract the pulsed laser light and the continuous wave laser light; a second grating provided adjacent to the first grating and configured to diffract again the pulsed laser light and the first continuous laser light; a mirror provided adjacent to the second grating and configured to reflect the pulsed laser light to the second grating; and a blocking plate provided between the mirror and the second grating and configured to block the continuous wave laser light.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a block diagram showing an example of a femtosecond fiber laser system according to the inventive concept;

FIG. 2 shows an application example of the femtosecond fiber laser system of FIG. 1;

FIG. 3 shows an application example of the femtosecond fiber laser system of FIG. 1;

FIG. 4 shows an application example of the femtosecond fiber laser system of FIG. 1;

FIG. 5 shows an application example of the femtosecond fiber laser system of FIG. 1;

FIGS. 6 and 7 are graphs respectively showing examples of wavelength bands of pulsed laser light and continuous laser light of FIG. 5; and

FIG. 8 shows an application example of the femtosecond fiber laser system of FIG. 1.

### DETAILED DESCRIPTION

Hereinafter, exemplary embodiments of the present disclosure will be described in conjunction with the accompanying drawings. The above and other aspects, features, and advantages of the present disclosure will become apparent from the detailed description of the following embodiments in conjunction with the accompanying drawings. However, it should be understood that the present invention is not limited to the following embodiments and may be embodied in different ways. Rather, the embodiments are provided so that so that this disclosure will be thorough and complete and will fully convey the concept of the invention to those skilled in the art, and the present disclosure will only be defined by the appended claims. Throughout this specification, like numerals refer to like elements.

The terminology used herein is for the purpose of describing particular embodiments only and is not intended to limit the scope of the present disclosure. As used herein, the singular forms “a”, “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof. Also, as just exemplary embodiments, reference numerals shown according to an order of description are not limited to the order.

Moreover, exemplary embodiments will be described herein with reference to cross-sectional views and/or plane views that are idealized exemplary illustrations. In the drawings, the thickness of layers and regions are exaggerated for effective description of the technical details. Accordingly, variations from the shapes of the illustrations as a result, for example, of manufacturing techniques and/or tolerances, are to be expected. Thus, exemplary embodiments should not be construed as limited to specific shapes illustrated herein but are to include deviations in shapes that result from manufacturing.

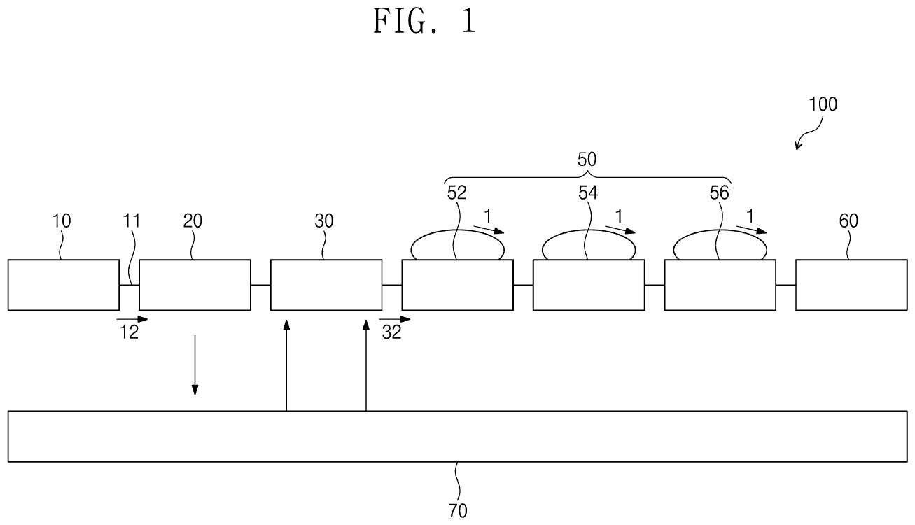

FIG. 1 shows an example of a femtosecond fiber laser system 100 according to the inventive concept.

Referring to FIG. 1, the femtosecond fiber laser system 100 according to the inventive concept may be the femtosecond fiber laser system 100 of a feedback structure. According to an example, the femtosecond fiber laser system 100 may include a femtosecond light source 10, a preamplifier 20, a pulse picker 30, a main amplifier 50, a pulse width compressor 60, and a controller 70.

The femtosecond light source 10 may generate femtosecond laser light 12. The femtosecond laser light 12 may have a frequency from about 10 MHz to about 1000 MHz.

The preamplifier 20 may be connected to the femtosecond light source 10. The preamplifier 20 may amplify the femtosecond laser light 12.

The pulse picker 30 may be connected to the preamplifier 20. The pulse picker 30 may modulate the femtosecond laser light 12 to generate pulsed laser light 32. The pulsed laser light 32 may have a frequency from about 0 Hz to about 20 MHz.

The main amplifier 50 may be provided between the pulse picker 30 and the pulse width compressor 60. The main amplifier 50 may amplify the pulsed laser light 32. According to an example, the main amplifier 50 may include a first main amplifier 52, a second main amplifier 54, and a third main amplifier 56. Each of the first main amplifier 52, the second main amplifier 54, and the third main amplifier 56 may use the pump light 1 to amplify the pulsed laser light 32.

The pulse width compressor 60 may be connected to the main amplifier 50. The pulse width compressor 60 may compress the pulse width of the pulsed laser light 32.

The femtosecond light source 10, the preamplifier 20, the pulse picker 30, the main amplifier 50, and the pulse width compressor 60 may be connected through optical fibers 11. The optical fiber 11 each may include a single-mode fiber. Alternatively, the optical fibers 11 each may include a multi-mode fiber, but is not limited thereto.

The controller 70 may control the preamplifier 20, the pulse picker 30, and the main amplifier 50. The controller 70 may control the preamplifier 20 and the pulse picker 30 to control generation of the femtosecond laser light 12 and the pulsed laser light 32. When the femtosecond laser light 12 and the pulsed laser light 32 do not operate due to a control of the controller 70 (namely, the pulsed laser light 32 is turned off), each of the first main amplifier 52, the second main amplifier 54, and the third main amplifier 56 may emit the ambient energy as CW laser light via an attenuation resonator included therein, and feedback the CW laser light to prevent burning of and damage to itself.

Accordingly, the femtosecond fiber laser system 100 of the inventive concept may use feedback the CW laser light via the attenuation resonator only during off-time of the pulsed laser light 32 to prevent the damage to the first main amplifier 52, the second main amplifier 54, and the third main amplifier 56.

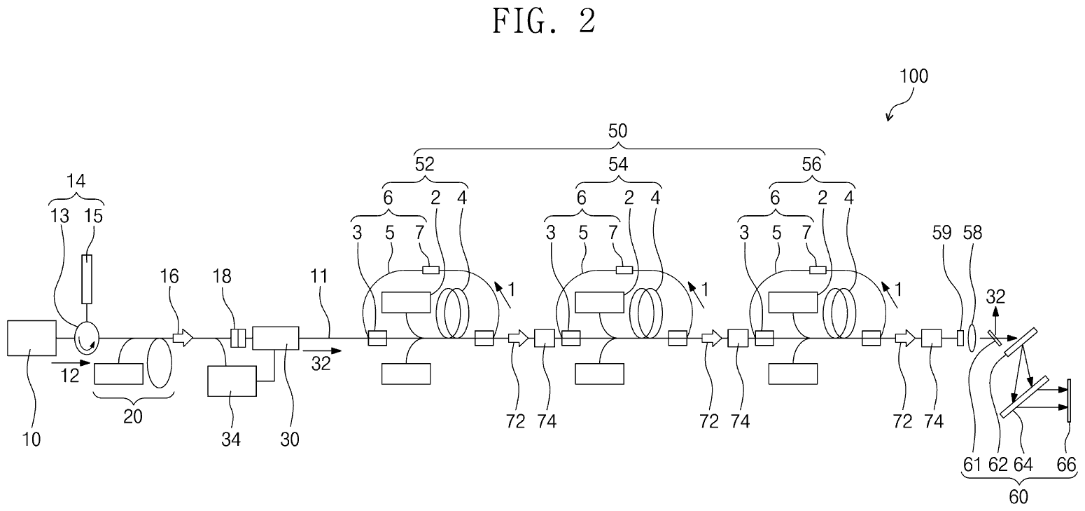

FIG. 2 shows an application example of the femtosecond fiber laser system 100 of FIG. 1.

Referring to FIG. 2, the femtosecond fiber laser system 100 of the inventive concept may further include a pulse width extender 14 and a picker controller 34.

The pulse width extender 14 may be provided between the femtosecond light source 10 and the preamplifier 20. The pulse width extender 14 may extend the pulse width of the femtosecond laser light 12. According to an example, the pulse width extender 14 may include a circulator 13 and a chirped fiber Bragg grating 15. The circulator 13 may be provided between the femtosecond light source 10 and the preamplifier 20. Although not shown, the circulator 13 may include at least one port. The chirped fiber Bragg grating 15 may be connected to the port of the circulator 13. The chirped fiber Bragg grating 15 may extend the pulse width of the femtosecond laser light 12.

A first isolator 16 may be provided in the optical fiber 11 between the preamplifier 20 and the pulse picker 30. The first isolator 16 may prevent return of the femtosecond laser light 12 to protect the preamplifier 20 and the femtosecond light source 10. The optical fiber 11 between the preamplifier 20 and the first isolator 16 may include a Yb-doped polarization-maintaining fiber as a gain medium fiber. The preamplifier 20 may include a laser diode.

The picker controller 34 may be connected to the pulse picker 30. The picker controller 34 may control a pulse repetition rate and the pulse trains. A fiber-to-fiber coupler 18 may be provided in the optical fiber 11 adjacent to the picker controller 34.

Each of the first main amplifier 52, the second main amplifier 54, and the third main amplifier 56 may use the pump light 1 to amplify the pulsed laser light 32, and protect the amplification stage by emitting, as the CW laser light, the ambient energy provided by the pump light 1 in the amplification stage only during off-time or idle time of the pulsed laser light 32.

According to an example, each of the first main amplifier 52, the second main amplifier 54, and the third main amplifier 56 may include pump light sources 2, a gain medium fiber 4, and a first attenuation resonator 6.

The pump light sources 2 may provide the pump light 1 to the gain medium fiber 4 to amplify the pulsed laser light 32. The pump light sources 2 may include laser diodes.

The gain medium fiber 4 may be provided adjacent to the pump light sources 2. When the pulsed laser light 32 and the pump light 1 are provided to the gain medium fiber 4, the gain medium fiber 4 may receive the pump light 1 to amplify the pulsed laser light 32. The gain medium fiber 4 may include an Yb-doped polarization-maintaining fiber.

The first attenuation resonator 6 may be connected to the fibers 11 on both sides of the pump light sources 2 and the gain medium fiber 4. The first attenuation resonator 6 and the optical fibers 11 may have a ring-type feedback structure. When the pulsed laser light 32 is not provided to the optical fiber 11, the first attenuation resonator 6 may reduce damage to the main amplifier 50 by emitting the ambient energy provided by the pump light 1 in the amplification stage as laser light at other specific wavelengths. In addition, the pulsed laser light 32 is provided to the fiber 11, the first attenuation resonator 6 may set the value of the attenuator so that the laser light emitted at the specific wavelengths may be automatically blocked inside the resonator. According to an example, the first attenuation resonator 6 may include couplers 3, a first feedback loop fiber 5, and a first attenuator 7.

The couplers 3 may be connected to one side of a point to which the pump light sources 2 are connected and the other side of the gain medium fiber 4. The couplers 3 may connect both terminals of the first feedback loop fiber 5 to the optical fiber 11. Each of the couplers 3 may include a wavelength division multiplexing (WDM) filter. Unlike this, each of the couplers 3 may include a polarization multiplexing combiner (PMC), but is not limited thereto.

The first feedback loop fiber 5 may be connected to the couplers 3 at both sides of the pump light sources 2 and the gain medium fiber 4. The first feedback loop fiber 5 may be connected to the optical fiber 11 via the couplers 3. The CW laser light 1 newly provided along the first feedback loop fiber 5 may travel in the inverse direction.

The first attenuator 7 may be coupled to the first feedback loop fiber 5. The first attenuator 7 may attenuate or absorb the CW laser light 1. Although not shown in FIG. 2, an inverse isolator or an optical filter having a narrow wavelength width may be further included in the first feedback loop fiber 1. As a result, the first feedback loop fiber 5 has the characteristics that the CW laser light 1 oscillates within the loop only during the turn-off of the pulsed laser light 32.

Accordingly, the femtosecond fiber laser system 100 of a feedback structure according to the inventive concept may use the pump light source 2 to amplify the pulsed laser light 32, and use the first attenuation resonator 6 to attenuate or remove the ambient energy increased by the pump light source 2 through the CW laser light 2. Namely, the value of the attenuator may be adjusted according to the intensity of the pulsed laser light 32 incident to each amplification stage so that the CW laser light 1 is automatically turned off during the turn-on of the pulsed laser light 32.

Referring to FIG. 2, second isolators 72 may be provided adjacent to the gain medium fibers of the first main amplifier 52, the second main amplifier 54, and the third main amplifier 56. The second isolators 72 may block the inverse flow of the pulsed laser light 32 to increase the amplification efficiencies of the first main amplifier 52, the second main amplifier 54, and the third main amplifier 56. Filters 74 may be provided adjacent to the second isolators 72. The filters 74 may remove noise of the pulsed laser light 32 amplified by the first main amplifier 52, the second main amplifier 54, and the third main amplifier 56.

An end cap 59 may be provided in the end of the gain medium fiber. The end cap 50 may reduce damage to the end of the optical fiber, the damage being caused by the amplified pulsed laser light 32. A lens 58 may be provided between the third main amplifier 56 and the pulse width compressor 60. The lens 58 may collimate the pulsed laser light 32 and continuous wave laser light 42 on the pulse width compressor 60.

The pulse width compressor 60 may be provided adjacent to the lens 58. The pulse width compressor 60 may compress the pulse width of the pulsed laser light 32. According to an example, the pulse width compressor 60 may include an output mirror 61, a first grating 62, a second grating 64, and a mirror 66.

The output mirror 61 may be provided between the third main amplifier 56 and the first grating 62. The output mirror 61 may be provided on the path of the pulsed laser light 32. The pulsed laser light 32 may be directly transmitted through the first grating 62 regardless of the output mirror 61.

The first grating 62 may be provided between the output mirror 61 and the second grating 64. The first grating 62 may diffract the pulsed laser light 32. The pulsed laser light 32 may be provided to the second grating 64.

The second grating 64 may be provided adjacent to the first grating 62. The second grating 64 may diffract again the pulsed laser light 32 and provide the pulsed laser light 32 to the mirror 66.

The mirror 66 may reflect the pulsed laser light 32 to the second grating 64. The pulsed laser light 32 may be sequentially provided to the second grating 64, the first grating 62, and the output mirror 61. The pulsed laser light 32 may be reflected by the output mirror 61 to be output outside.

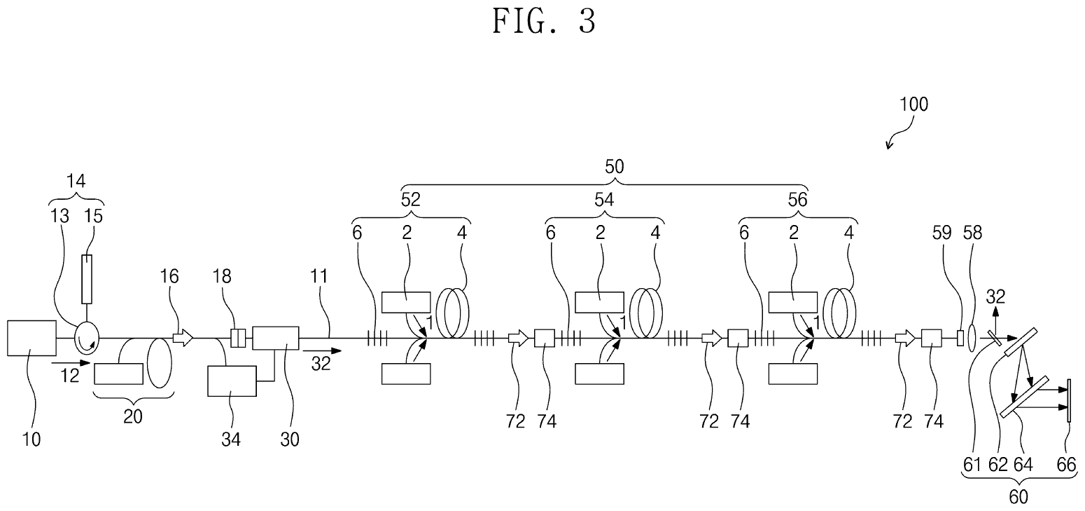

FIG. 3 shows an application example of the femtosecond fiber laser system 100 of FIG. 1.

Referring to FIG. 3, each of the first attenuation resonators 6 of the femtosecond fiber laser system 100 according to the inventive concept may include fiber Bragg gratings. The fiber Bragg gratings may prevent damage to the amplification stage by using the pump light 1 to resonate the CW laser light only during the turn-off of the pulsed laser light 32. Although not shown in FIG. 3, during the turn-on of the pulsed laser light 32, the CW laser light may be adjusted to be automatically turned off by the high power pulsed laser light 32 by adjusting the reflectivity of the fiber Bragg gratings. Each of the first attenuation resonators 6 may include a chirped fiber Bragg grating (CFBG), but is not limited thereto.

The femtosecond light source 10, the pulse width extender 14, the preamplifier 20, the pulse picker 30, the pump light source 2, the gain medium fiber 4, and the pulse width compressor 60 may be included in the same way as FIG. 1.

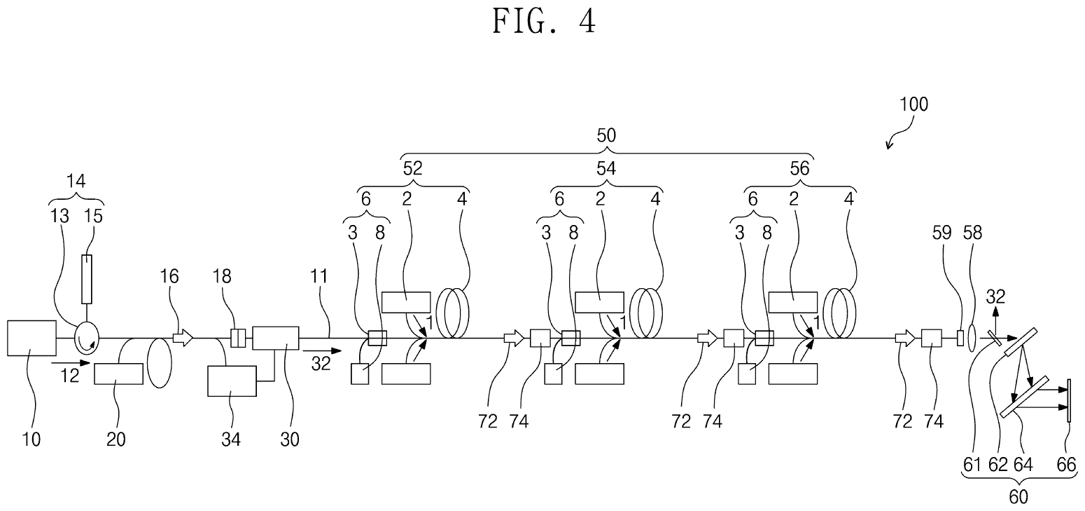

FIG. 4 shows an application example of the femtosecond fiber laser system 100 of FIG. 1.

Referring to FIG. 4, each of the first attenuation resonators 6 of the femtosecond fiber laser system 100 according to the inventive concept may include a coupler 3 and an amplified spontaneous emission (ASE) mirror 8.

The coupler 3 may be connected to the fiber 11 at one sides of the pump light sources 2.

The ASE mirror 8 may be connected to the coupler 3. The ASE mirror 8 may reflect ASE traveling in the inverse direction at the amplification stage to the laser light travel direction. The value of the reflectivity of the ASE mirror 8 may be adjusted according to the intensity of the pulsed laser light 32 incident to the corresponding amplification stage. Accordingly, damage to the amplification stage may be prevented by reflecting high value ASE automatically provided during the turn-off of the pulsed laser light 32 back to the amplification stage. During the turn-on of the pulsed laser light 32, automatically provided low value ASE may be reflected and the value of the reflected ASE may be adjusted through the reflectivity of the mirror.

The femtosecond light source 10, the pulse width extender 14, the preamplifier 20, the pulse picker 30, the pump light source 2, the gain medium fiber 4, and the pulse width compressor 60 may be composed in the same way as FIG. 1.

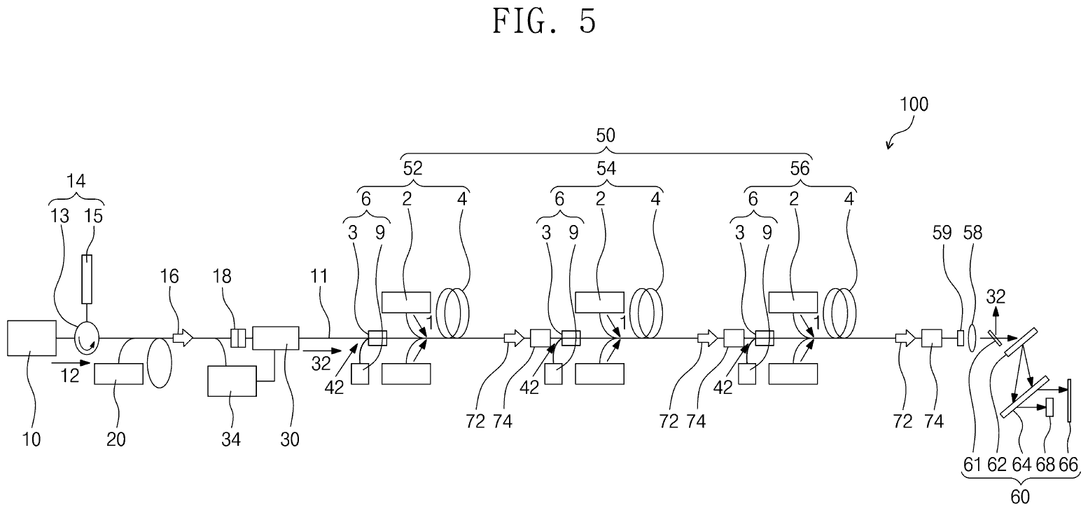

FIG. 5 shows an application example of the femtosecond fiber laser system 100 of FIG. 1.

Referring to FIG. 5, each of the first attenuation resonators 6 of the femtosecond fiber laser system 100 according to the inventive concept may include a coupler 3 and a continuous wave light source 9.

The coupler 3 may be connected to the fiber 11 at one sides of the pump light sources 2.

The continuous wave light source 9 may be connected to the coupler 3 to provide the continuous laser light 42 to the coupler 3, the optical fiber 11, and the gain medium fiber 4. The continuous laser light 42 and the pulsed laser light 32 may be amplified by the pump light 1. When the pulsed laser light 32 is turned off, the continuous laser light 42 may be amplified by the pump light 1 to prevent damage to the first main amplifier 52, the second main amplifier 54, and the third main amplifier 56.

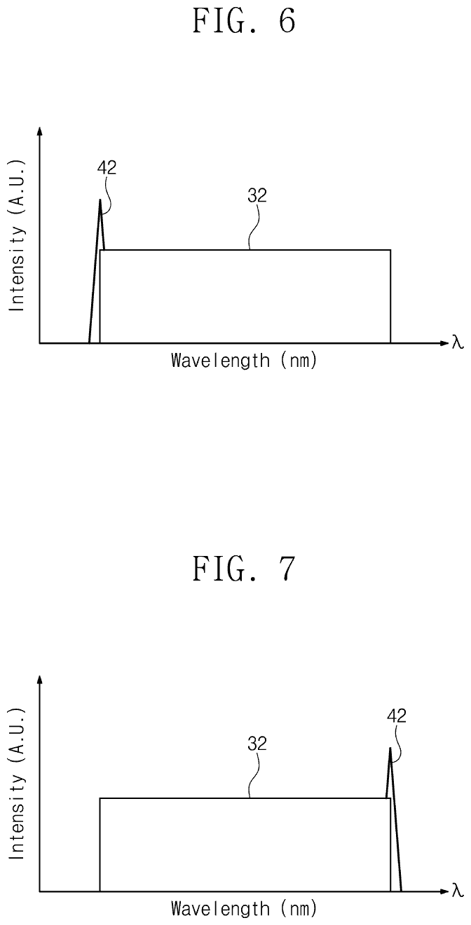

FIGS. 6 and 7 respectively show wavelength band examples of the pulsed laser light 32 and the continuous laser light 42 of FIGS. 2 to 5.

Referring to FIGS. 6 and 7, a wavelength peak of the continuous wave laser light 42 may overlap with or abut on any one of both ends of the wavelength band of the pulsed laser light 32, or may be or may not be overlapped but may be present within a wavelength band of a filter in the amplifier.

Referring to FIG. 5, the pulse width compressor 60 may further include a blocking plate 68. The blocking plate 68 may be provided between the second grating 64 and the mirror 66. The blocking plate 68 may block or remove the continuous wave laser light 42.

The femtosecond light source 10, the pulse width extender 14, the preamplifier 20, the pulse picker 30, the pump light source, and the gain medium fiber 4 may be composed in the same way as FIG. 2. In addition, the output mirror 61, the first grating 62, the second grating 64, and the mirror 66 of the pulse width compressor 60 may also be composed in the same way as FIG. 2.

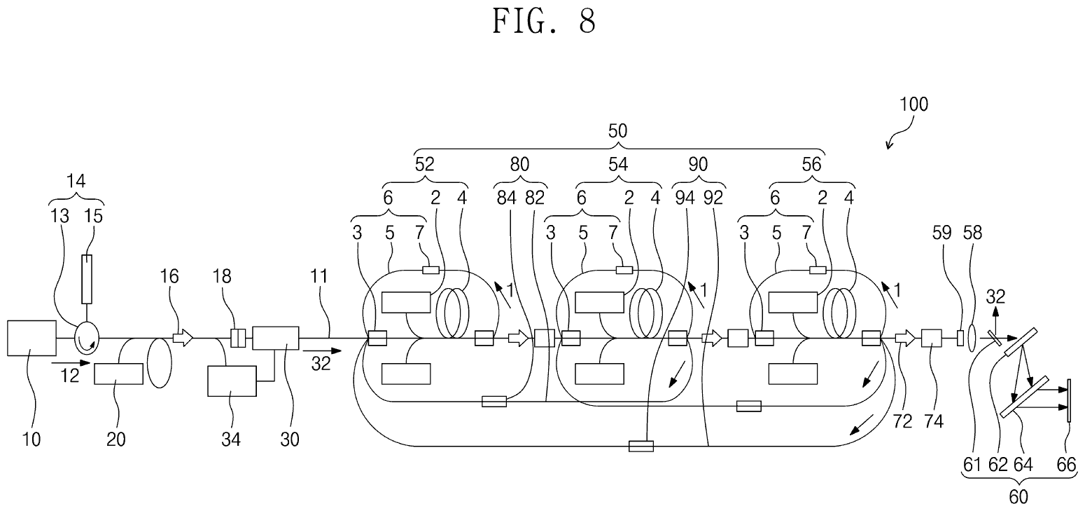

FIG. 8 shows an application example of the femtosecond fiber laser system 100 of FIG. 1.

Referring to FIG. 8, in the femtosecond fiber laser system 100 of a feedback structure according to the inventive concept, the main amplifier 50 may further include second attenuation resonators 80 and a third attenuation resonator 90. The femtosecond light source 10, the pulse width extender 14, the preamplifier 20, the first main amplifier 52, the second main amplifier 54, the third main amplifier 56, and the pulse width compressor 60 may be included in the same way as FIG. 2.

The second attenuation resonators 80 may be connected to the couplers 3 at both sides of the first main amplifier 52 and the second main amplifier 54, and to the couplers 3 at both sides of the second main amplifier 54 and the third main amplifier 56. When the pulsed laser light 32 is turned off, the second attenuation resonators 80 may remove the ambient energy increased by the pump light beams through the CW laser light. During the turn-on of the pulsed laser light 32, the value of the attenuators may be adjusted to turn off the CW laser light. According to an example, each of the second attenuation resonators 80 may include a second feedback loop fiber 82 and a second attenuator 84.

The second feedback loop fiber 82 may be longer than the first feedback loop fiber 5. The second feedback loop fiber 82 may be branched from the coupler 3 at one side of the first main amplifier 52 to be connected to the coupler 3 at the other side of the second main amplifier 54. In addition, the second feedback loop fiber 82 may be branched from the coupler 3 at one side of the second main amplifier 54 to be connected to the coupler 3 at the other side of the third main amplifier 56. The pump light 1 may be transferred along the second feedback loop fiber 82.

The second attenuator 84 may be connected to the second feedback loop fiber 82. The second attenuator 84 may adjust the intensity of the oscillating laser light 1 when the pulsed laser light 32 is turned off. Accordingly, when the pulsed laser light 32 is turned on, the automatically oscillating laser light 1 may be turned off.

The third attenuation resonator 90 may be connected to both sides of the first main amplifier 52, the second main amplifier 54, and the third main amplifier 56. When the pulsed laser light 32 is turned off, the third attenuation resonator 90 may remove the ambient energy increased by the pump light beams through the CW laser light. According to an example, the third attenuation resonator 90 may include a third feedback loop fiber 92 and a third attenuator 94.

The third feedback loop fiber 92 may be longer than the second feedback loop fiber 82. The third feedback loop fiber 92 may be branched from the coupler 3 at one side of the first main amplifier 52 to be connected to the coupler 3 at the other side of the third main amplifier 56.

The third attenuator 94 may be connected to the third feedback loop fiber 92. The third attenuator 94 may adjust the intensity of the oscillating laser light when the pulsed laser light 32 is turned off. Accordingly, when the pulsed laser light 32 is turned on, the automatically oscillating laser light may be turned off.

As described above, the femtosecond fiber laser system of a feedback structure according to an embodiment of the inventive concept may use the main amplifier including the pump light source and the first attenuation resonator connected to the pump light source to remove and omit the optical shutter element, and prevent damage to the main amplifier during off-time of the pulsed laser light.

The exemplary embodiments of the present disclosure have been described above with reference to the accompanying drawings, but those skilled in the art will understand that the present disclosure may be implemented in another concrete form without changing the technical spirit or an essential feature thereof. Therefore, the aforementioned exemplary embodiments are all illustrative and are not restricted to a limited form.

What is claimed is:

1. A femtosecond fiber laser system of a feedback structure comprising:
a femtosecond light source configured to generate femtosecond laser light;
a pulse picker connected to the femtosecond laser light source and configured to modulate the femtosecond laser light to generate pulsed laser light;
a first main amplifier, a second main amplifier, and a third main amplifier connected to the pulse picker and configured to amplify the pulsed laser light; and
an optical fiber connected from the femtosecond light source to the third main amplifier,
wherein each of the first main amplifier, the second main amplifier, and the third amplifier comprises:
a pump light source configured to generate pump light for amplifying the pulsed laser light; and
a first attenuation resonator connected to the pump light source and configured to attenuate or remove the pump light during a turn-off time of the pulsed laser light.

2. The femtosecond fiber laser system of a feedback structure according to claim 1, wherein the first attenuation resonator comprises:
couplers provided in the optical fiber at front and back ends of the pump light source;
a first feedback loop fiber connected to the couplers; and
a first attenuator connected to the first feedback loop fiber.

3. The femtosecond fiber laser system of a feedback structure according to claim 2, further comprising:
a second feedback loop fiber connected between the coupler between the first main amplifier and the pulse picker, and the coupler between the second main amplifier and the third main amplifier, the second feedback loop fiber having a longer length than the first feedback loop fiber; and
a second attenuator connected to the second feedback loop fiber.

4. The femtosecond fiber laser system of a feedback structure according to claim 3, further comprising:
a third feedback loop fiber connected between the coupler between the first main amplifier and the pulse picker, and the coupler provided at another side of the third main amplifier, the third feedback loop fiber having a longer length than the second feedback loop fiber; and
a third attenuator connected to the third feedback loop fiber.

5. The femtosecond fiber laser system of a feedback structure according to claim 2, wherein each of the couplers comprises a wavelength division multiplexing (WDM) filter or a polarization multiplexing combiner (PMC).

6. The femtosecond fiber laser system of a feedback structure according to claim 1, wherein each of the first main amplifier, the second main amplifier, and the third main amplifier further comprises a gain medium fiber provided adjacent to the pump light source.

7. The femtosecond fiber laser system of a feedback structure according to claim 6, wherein the first attenuation resonator comprises fiber Bragg gratings provided in the optical fiber at both sides of the pump light source and the gain medium fiber.

8. The femtosecond fiber laser system of a feedback structure according to claim 6, wherein the first attenuation resonator comprises a resonant mirror provided in the optical fiber connected to the pump light source.

9. The femtosecond fiber laser system of a feedback structure according to claim 6, wherein the first attenuation resonator comprises a continuous wave laser light source provided in the fiber connected to the pump light source and configured to provide continuous wave laser light.

10. The femtosecond fiber laser system of a feedback structure according to claim 9, further comprising:
a pulse width compressor connected to the third main amplifier,
wherein the pulse width compressor comprises:
an output mirror;
a first grating provided adjacent to the output mirror and configured to diffract the pulsed laser light and the continuous wave laser light;
a second grating provided adjacent to the first grating and configured to diffract again the pulsed laser light and the first continuous laser light;
a mirror provided adjacent to the second grating and configured to reflect the pulsed laser light to the second grating; and
a blocking plate provided between the mirror and the second grating and configured to block the continuous wave laser light.

11. A femtosecond fiber laser system of a feedback structure comprising:
a femtosecond light source configured to generate femtosecond laser light;
a pulse width extender configured to extend a pulse width of the femtosecond laser light;
a preamplifier configured to amplify the femtosecond laser light;
a pulse picker configured to modulate the femtosecond laser light to generate pulsed laser light;
a first main amplifier, a second main amplifier, and a third main amplifier configured to amplify the pulsed laser light; and
a pulse width compressor provided adjacent to the third main amplifier and configured to compress a pulse width of the pulsed laser light,
wherein each of the first main amplifier, the second main amplifier, and the third amplifier comprises:
a pump light source configured to generate pump light;
a gain medium fiber provided adjacent to the pump light source and configured to absorb the pump light to amplify the pulsed laser light; and
a first attenuation resonator connected to both sides of the pump light source and the gain medium fiber and configured to attenuate or remove the pump light during a turn-off time of the pulsed laser light.

12. The femtosecond fiber laser system of a feedback structure according to claim 11, wherein the first attenuation resonator comprises:
couplers respectively provided at both sides of the pump light and the gain medium fiber;
a first feedback loop fiber connected to the couplers; and
a first attenuator connected to the first feedback loop fiber.

13. The femtosecond fiber laser system of a feedback structure according to claim 12, further comprising:
a second feedback loop fiber branched from the coupler between the first main amplifier and the pulse picker, and connected to the coupler between the second main amplifier and the third main amplifier, the second feedback loop fiber having a longer length than the first feedback loop fiber; and
a second attenuator connected to the second feedback loop fiber.

14. The femtosecond fiber laser system of a feedback structure according to claim 13, further comprising:
a third feedback loop branched from the coupler between the first main amplifier and the pulse picker, and connected to the coupler between the third main amplifier and the pulse width compressor, the third feedback loop fiber having a longer length than the second feedback loop fiber; and
a third attenuator connected to the third feedback loop fiber.

15. The femtosecond fiber laser system of a feedback structure according to claim 11, wherein the first attenuation resonator comprises fiber Bragg gratings provided at both sides of the pump light and the gain medium fiber.

16. The femtosecond fiber laser system of a feedback structure according to claim 11, wherein the first attenuation resonator comprises a resonant mirror provided at one side of the pump light source.

17. The femtosecond fiber laser system of a feedback structure according to claim 11, wherein the first attenuation resonator comprises a continuous wave laser light source connected to one side of the pump light source and configured to provide continuous wave laser light.

18. The femtosecond fiber laser system of a feedback structure according to claim 17, wherein the pulse width compressor comprises:
an output mirror;
a first grating provided adjacent to the output mirror and configured to diffract the pulsed laser light and the continuous wave laser light;
a second grating provided adjacent to the first grating and configured to diffract again the pulsed laser light and the first continuous laser light;
a mirror provided adjacent to the second grating and configured to reflect the pulsed laser light to the second grating; and
a blocking plate provided between the mirror and the second grating and configured to block the continuous wave laser light.
